(19) United States
(12) Patent Application Publication
(10) Pub. No.: US 2015/0220964 A1
(43) Pub. Date: Aug. 6, 2015

(54) INFORMATION PROCESSING DEVICE AND METHOD OF SETTING ITEM TO BE RETURNED

(71) Applicant: NEC Corporation, Tokyo (JP)

(72) Inventors: Tadashi Itani, Tokyo (JP); Rumi Ikezawa, Tokyo (JP)

(21) Appl. No.: 14/418,658

(22) PCT Filed: Apr. 12, 2013
(86) PCT No.: PCT/JP2013/061022

§ 371 Date: Jan. 30, 2015

(30) Foreign Application Priority Data
Aug. 3, 2012 (JP) 2012-173416

(51) Int. Cl. G06Q 30/02; G06Q 20/20

(52) U.S. Cl. CPC G06Q 30/0238; G06Q 20/203

(57) ABSTRACT

An information processing device includes: a retaining unit that retains completed transaction data formed by plural statement records each including at least a product code of a product included in a completed transaction, and special sales information that enables determination as to whether a product is a limited sales product to which a limited sales price is applied; an acquiring unit that acquires a product code and special sales information, each of which concerns a candidate to be returned selected through user operation performed on an item return screen; a judging unit that judges whether a relevant statement record is contained in the retained completed transaction data and the special sales information concerning the candidate to be returned indicates a limited sales product to which a limited sales price is applied or not, the relevant statement record being a record other than a statement record including the product code and the special sales information, each of which concerns a candidate to be returned, the relevant statement record including a product code the same as the product code concerning the candidate to be returned, the relevant statement record including the special sales information indicating that the product is not a limited sales product to which a limited sales price is applied.

### TECHNICAL FIELD

The present invention relates to a point of sale (POS) terminal and a POS system.

### BACKGROUND ART

Retail stores such as supermarkets and department stores sometimes hold a limited sale in which discount is applied to only a limited quantity of products eligible for the discount. If products for which the limited sale is offered are purchased over the quantity limit, a regular price is generally applied to a surplus quantity of products exceeding the quantity limit. Hereinafter, the product eligible for the limited sale is referred to as a limited sales product. Furthermore, of the limited sales products, limited-sale-price applied products represent products of which quantity falls within the quantity limit and to which the limited sales price after discount is applied, whereas limited-sale-price unapplied products represent a surplus quantity of products that exceeds the quantity limit and to which the limited sales price is not applied.

A register operator has to pay attention when registering, to the POS terminal, the limited sales products of which quantity exceeds the quantity limit. For example, the register operator him/herself needs to check whether the quantity of the limited sales products is greater than the quantity limit. To deal with this, Patent Document 1 described below proposes a method of managing a limited sales product, of which quantity is limited, purchased by one customer by judging whether the product is a limited sales product; capturing an image of the customer who purchases the product; counting the quantity of the limited sales product sold to the same customer on the basis of information on the customer whose image is captured, and the quantity of product judged as the limited sales product.

### RELATED DOCUMENT

### Patent Document

Patent Document 1: Japanese Patent Application Laid-open No. 2012-89024

### SUMMARY OF THE INVENTION

### Problem to be Solved by the Invention

However, the proposed method described above does not take into consideration a case where the limited sales product is returned. In the case of a transaction that has been settled and includes one or more surplus of the limited sales product of which quantity exceeds the quantity limit, if any limited sales product is returned, a limited-sale-price unapplied product needs to be first treated as an item to be returned with a high priority. This is because, if the limited-sale-price applied product is preferentially treated as the item to be returned even though the limited-sale-price unapplied product is included, the purchaser who desires to return the product would receive a refund corresponding to the limited sales price. This means that, in such a case, this customer could not purchase the product at the special sales price even if the customer purchased the limited sales product at a quantity equal to or less than the quantity limit.

The present invention has been made in view of the circumstances described above, and provides a technique that supports a register operator to appropriately perform setting of a limited sales product to be returned.

### Means for Solving the Problem

Each aspect of the present invention employs the following configurations to solve a problem described above.

An information processing device according to the first aspect, which includes: a transaction-data retaining unit that retains completed transaction data indicating a completed transaction for which settlement processing has been already completed, the completed transaction data being formed by plural statement records each including at least a product code that enables identification of each product included in the completed transaction, and special sales information that enables determination as to whether a product is a limited sales product to which a limited sales price is applied; a display processing unit that causes a display unit to display an item return screen that enables user operation of selecting a candidate to be returned from among data corresponding to the plural statement records contained in the completed transaction data; an operation-information acquiring unit that acquires the product code and the special sales information, each of which concerns the candidate to be returned selected through the user operation performed on the item return screen; a judging unit that judges whether a relevant statement record is contained in the completed transaction data retained in the transaction-data retaining unit and the special sales information concerning the candidate to be returned indicates a limited sales product to which a limited sales price is applied or not, the relevant statement record being a record other than a statement record including the product code and the special sales information, each of which concerns the candidate to be returned, the relevant statement record including a product code the same as the product code concerning the candidate to be returned, the relevant statement record including the special sales information indicating that the product is not a limited sales product to which a limited sales price is applied; and the; and a setting processing unit that determines a process performed in response to the user operation, on the basis of a judgment result obtained by the judging unit.

The second aspect relates to a method of setting an item to be returned performed by an information processing device. The method of setting an item to be returned according to the second aspect includes: retaining, in a transaction-data retaining unit, completed transaction data indicating a completed transaction for which settlement processing has been already completed, the completed transaction data being formed by plural statement records each including at least a product code that enables identification of each product included in the completed transaction, and special sales information that enables determination as to whether a product is a limited sales product to which a limited sales price is applied; causing a display unit to display an item return screen that enables user operation of selecting a candidate to be returned from among data corresponding to the plural statement records contained in the completed transaction data; acquiring the product code and the special sales information, each of which concerns the candidate to be returned selected through the user operation performed on the item return screen; judging whether a relevant statement record is contained in the completed transaction data retained in the transaction-data retaining unit and the special sales information concerning the candidate to be returned indicates a limited sales product to which a limited sales price is applied or not, the relevant statement record being a record other than a statement record including the product code and the special sales information, each of which concerns the candidate to be returned, the relevant statement record including a product code the same as the product code concerning the candidate to be returned, the relevant statement record including the special sales information indicating that the product is not a limited sales product to which a limited sales price is applied; and determining a process performed in response to the user operation, on the basis of a judgment result.

It should be noted that other aspects of the present invention may include a program that causes the information processing device to realize the configuration of the first aspect described above, or may include a computer-readable storage medium that records such a program. This storage medium includes a non-transitory tangible medium.

### Effect of the Invention

According to the aspects described above, it is possible to provide a technique that supports a register operator to appropriately set a limited sales product to be returned.

### BRIEF DESCRIPTION OF THE DRAWINGS

The above-described object, other objects, features and advantages will be made further clear by the preferred exemplary embodiments described below and the following drawings attached thereto.

FIG. 1 is a diagram illustrating a configuration example of an appearance of a POS register device according to a first exemplary embodiment.

FIG. 2 is a diagram schematically illustrating an example of a hardware configuration of the POS register device according to the first exemplary embodiment.

FIG. 3 is a diagram schematically illustrating an example of a process configuration of part of the POS register device according to the first exemplary embodiment.

FIG. 4 is a diagram illustrating an example of a display screen that allows a user to identify a completed transaction including a candidate to be returned.

FIG. 5 is a diagram illustrating an example of an item return screen.

FIG. 6 is a flowchart showing an example of operations performed by the POS register device according to the first exemplary embodiment at the time of setting an item to be returned.

FIG. 7 is a diagram schematically illustrating an example of a configuration of a POS system according to a modification example.

### DESCRIPTION OF EMBODIMENTS

Hereinbelow, an exemplary embodiment according to the present invention will be described. Note that each exemplary embodiment described below is merely an example, and the present invention is not limited to the configuration of each exemplary embodiment described below.

### First Exemplary Embodiment

### Device Configuration

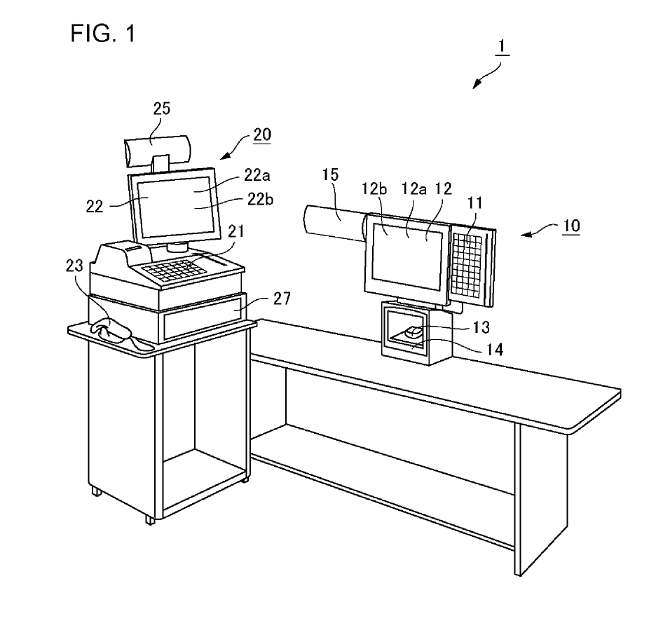

FIG. 1 is a diagram illustrating a configuration example of an appearance of a POS register device according to a first exemplary embodiment. As illustrated in FIG. 1, the POS register device 1 according to the first exemplary embodiment includes a checker device 10 and a cashier device 20. The POS register device 1, the checker device 10, and the cashier device 20 are also referred to as POS terminals.

The checker device 10 registers a product as an item to be checked out, and transmits information on the product to be checked out to the cashier device 20. The checker device 10 includes, for example, a keyboard 11, a touch screen unit 12, a scanning device 13, and a display 15 for purchaser. The display 15 for purchaser displays, for example, selling-price information on a product registered as an item to be checked out.

The touch screen unit 12 includes, for example, a display unit 12a, a touch screen 12b that receives user operations, and a controlling unit. The touch screen unit 12 causes the display unit 12a to display a screen corresponding to received drawing data, and receives input from a user (a member of staff such as a register operator) by sensing touch to the touch screen 12b from the outside. The touch screen unit 12 transmits the input information acquired. The display unit 12a displays, for example, a sales registration screen indicating a list of products registered as items to be checked out.

The scanning device 13 detects a product identification label attached on a package of a product held toward a scanning window 14, and furthermore, captures a product image showing the appearance of this product. More specifically, the scanning device 13 causes light from the product through the scanning window 14 to be focused, as an optical image, onto image sensors such as charge coupled devices (CCD), and acquires image data on this product on the basis of electrical signals corresponding to this image. The scanning device 13 may detect the product identification label from the product image captured by the image sensor. In this case, the scanning device 13 has a function of automatically adjusting a focal length, an angle of view or the like at the time of capturing the product image as well as at the time of capturing an image of the product identification label. Furthermore, the scanning device 13 may further include a laser scanner, and detect the product identification label using this laser scanner.

Here, the product identification label represents a code symbol in which a product code, which is formed by a character, number, sign, or the like and from which each product can be identified, is encoded, and is realized, for example, in a form of a one-dimensional bar code, a two-dimensional bar code, and so on. This exemplary embodiment does not limit the way in which the product identification label is realized, provided that the product code can be extracted from the product identification label. The scanning device 13 extracts the product code by decoding the detected product identification label.

Furthermore, the product code is identification data set in advance for identifying each product, and formed, for example, by characters, numbers, and symbols. For the product code, a Price Look Up (PLU) code, a Non-PLU code, and the like are used, for example. Furthermore, for the product code read with the product identification label, a Japan Article Number (JAN) code is used, for example.

As described above, the checker device 10 identifies the product, for example, on the basis of a product code extracted from the product identification label using the scanning device 13, a product code acquired by operation of the checkout screen, or a product code directly inputted using, for example, the keyboard 11, and registers this product as the item to be checked out.

The cashier device 20 performs settlement processing for a product to be checked out. Basically, the checker device 10 registers an item to be checked out as described above. However, the cashier device 20 itself may additionally register the item to be checked out. In such a case, the cashier device 20 identifies the product on the basis of a product code acquired, for example, from the product identification label using a handheld scanner 23, or a product code (or a segment code) directly inputted using, for example, a keyboard 21, and additionally registers this product as the item to be checked out.

The cashier device 20 includes, for example, the keyboard 21, a touch screen unit 22, the handheld scanner 23, a display 25 for purchaser, and a cash drawer 27. The cash drawer 27 stores paper money, coins, cash voucher or other form of money used in settlement of products. In this exemplary embodiment, an example is given in which the cash drawer 27 has an automated change machine.

The touch screen unit 22 has a configuration similar to that of the touch screen unit 12 described above, and the touch screen unit 22 includes, for example, a display unit 22a and a touch screen 22b. The display unit 22a displays, for example, a sales registration screen and a payment screen. The display 25 for purchaser displays, for example, the total purchase price and the amount of change.

The handheld scanner 23 reads the product identification label attached on a package of the product as is the case with the scanning device 13 described above, and furthermore, captures a product image showing the appearance of the product. It is only necessary that the handheld scanner 23 has a configuration similar to that of the scanning device 13 described above, and hence, explanation thereof will not be repeated.

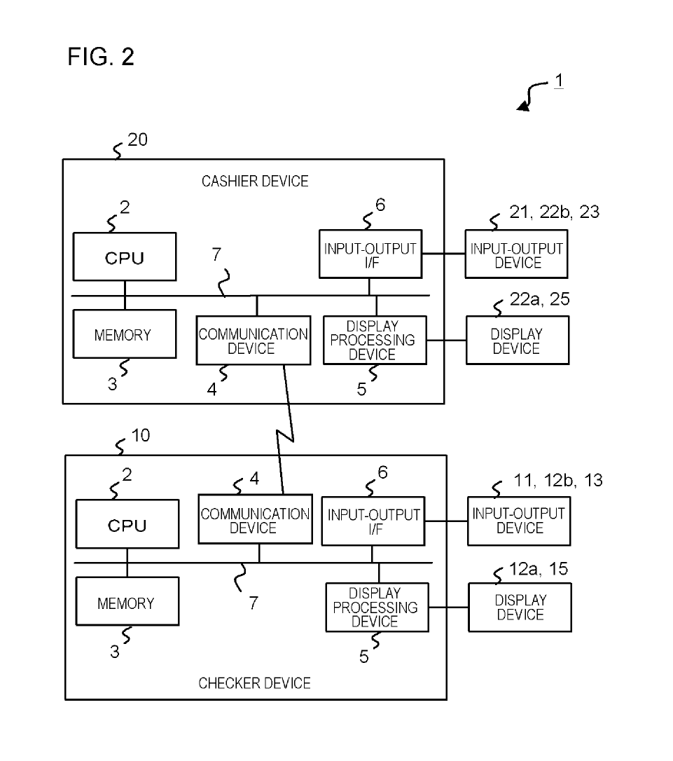

FIG. 2 is a diagram schematically illustrating an example of a hardware configuration of the POS register device 1 according to the first exemplary embodiment. As illustrated in FIG. 2, the checker device 10 includes, for example, a central processing unit (CPU) 2, a memory 3, a communication device 4, a display processing device 5, and an input-output interface (I/F) 6. These units are connected, for example, to a bus 7. The memory 3 includes, for example, a random access memory (RAM), a read only memory (ROM), a hard disk, and a portable storage medium. The communication device 4 communicates with other devices (for example, the cashier device 20) in a wired or wireless manner.

The display processing device 5 is connected to a display device, and transmits, to the display device, a screen-displaying signal for displaying a given screen in accordance with a process performed by the CPU 2. The checker device 10 includes the display 15 for purchaser and the display unit 12a of the touch screen unit 12, each of which serves as the display device.

The input-output I/F 6 is connected to an input-output device. The input-output I/F 6 outputs, for example, voice to an output device in accordance with a process performed by the CPU 2, and receives an input signal from an input device. The checker device 10 includes the keyboard 11, the touch screen 12b of the touch screen unit 12, and the scanning device 13, each of which serves as the input-output device.

The cashier device 20 includes, for example, a CPU 2, a memory 3, a communication device 4, a display processing device 5, and an input-output I/F 6 as is the case with the checker device 10. The cashier device 20 includes the display 25 for purchaser and the display unit 22a of the touch screen unit 22, each of which serves as the display device. The cashier device 20 includes the keyboard 21, the touch screen 22b of the touch screen unit 22, and the handheld scanner 23, each of which serves as the input-output device.

It should be noted that this exemplary embodiment does not limit the hardware configurations of the checker device 10 and the cashier device 20 as described above. For example, the keyboards 11 and 21 may be replaced with software keyboards. Furthermore, the displays 15 and 25 for purchaser may be integrated as one unit, or may display contents equivalent to those displayed on the display unit 12a of the touch screen unit 12 and the display unit 22a of the touch screen unit 22.

### [Process Configuration]

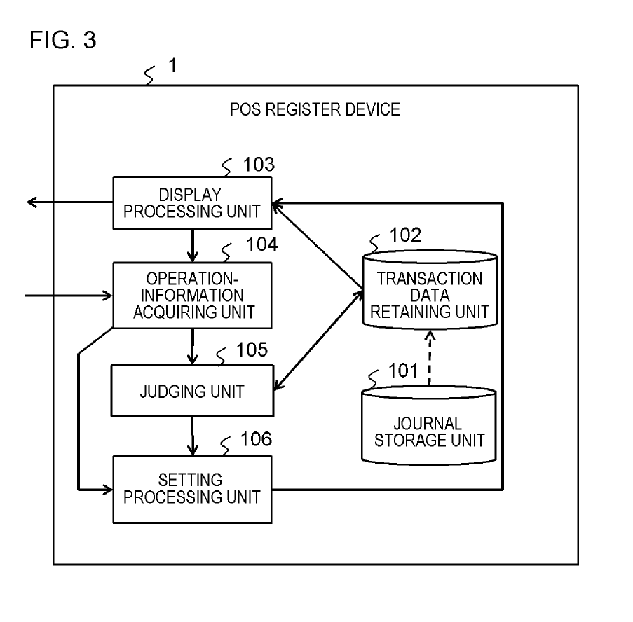

FIG. 3 is a diagram schematically illustrating an example of a process configuration of part of the POS register device 1 according to the first exemplary embodiment. The POS register device 1 includes, for example, a journal storage unit 101, a transaction-data retaining unit 102, a display processing unit 103, an operation-information acquiring unit 104, a judging unit 105, and a setting processing unit 106. Each of these processing modules is realized, for example, with the CPU 2 running a program stored in the memory 3. Furthermore, this program may be installed, for example, from a portable storage medium such as a compact disc (CD) and a memory card or from other devices, and may be stored in the memory 3.

Although FIG. 3 illustrates only the process configuration related to returning an item, the POS register device 1 has a large number of processing modules other than those illustrated in the drawing. Furthermore, in FIG. 3, the checker device 10 and the cashier device 20 are not illustrated in a separated manner. Each of the processing modules, however, is realized in the cashier device 20. Note that the transaction-data retaining unit 102, the display processing unit 103, the operation-information acquiring unit 104, and the judging unit 105 may be realized in both the checker device 10 and the cashier device 20.

The journal storage unit 101 stores sales information concerning each completed transaction for which settlement processing has been completed, as journal data. The sales information concerning each completed transaction includes, for example, product information on each product included in the completed transaction, the amount of money paid according to types of payment form used, the total amount of money for products purchased, and the amount of change. Furthermore, the product information includes, for example, a product code that enables identification of the product (a segment code or other information may be used), the quantity sold, a unit price, the discount amount, and a limited sales price application flag. The limited sales price application flag indicates, for example, that a product is a limited-sales-price applied product in the case where the flag is on, and a product is not a limited-sales-price applied product in the case where the flag is off.

The transaction-data retaining unit 102 retains completed transaction data indicating a completed transaction related to an item to be returned. The completed transaction data is generated, for example, on the basis of sales information extracted from the journal storage unit 101. The completed transaction data may be sales information itself, which is stored in the journal storage unit 101, or may be part of the sales information. The completed transaction data includes plural statement records each containing at least a product code that enables identification of the product included in the completed transaction, special sales information that enables determination as to whether the product is a limited-sales-price applied product, and the quantity sold. For example, the special sales information is a limited-sales-price application flag contained in the sales information described above. Furthermore, in the case where whether a product is the limited-sales-price applied product can be determined on the basis of the discount amount, the discount amount may be set as the special sales information.

This exemplary embodiment does not limit a form of one statement record constituting the completed transaction data. Hereinbelow, the form of a statement record will be described in details by giving an example of a completed transaction in which a tomato is a limited sales product priced at a limited sales price of 25 yen per item for a limit of five tomatoes, and priced at 35 yen per item for the sixth or more; and a register operator registers three tomatoes, one lettuce, two tomatoes, one cucumber, and two tomatoes in this order as items to be checked out.

One statement record of the completed transaction data may be set, for example, for each registration performed to the POS register device 1 as an item to be checked out. In such a case, the completed transaction data is formed by the following five records: a statement record indicating three tomatoes serving as a limited-sales-price applied product, a statement record indicating one lettuce, a statement record indicating two tomatoes serving as the limited-sales-price applied product, a statement record indicating one cucumber, and a statement record indicating two tomatoes serving as a limited-sales-price unapplied product.

As for another form of the completed transaction data, one statement record of the completed transaction data may be set such that the product code, the unit price, and the discount amount are set using the same unit, regardless of the way in which products are registered as items to be checked out. In such a case, the completed transaction data is formed by the following four records: a statement record indicating five tomatoes serving as the limited-sales-price applied product, a statement record indicating one lettuce, a statement record indicating one cucumber, and a statement record indicating two tomatoes serving as the limited-sales-price unapplied product.

The display processing unit 103 uses completed transaction data retained in the transaction-data retaining unit 102 to cause the display unit 22a to display an item return screen that enables user operation of selecting a candidate to be returned from among data corresponding to plural statement records contained in the completed transaction data. At this time, the display processing unit 103 causes the display unit 22a to display a display screen for a user (a register operator) to identify a completed transaction containing the candidate to be returned, and retains, in the transaction-data retaining unit 102, the completed transaction data on the completed transaction identified through the user operation performed to this display screen.

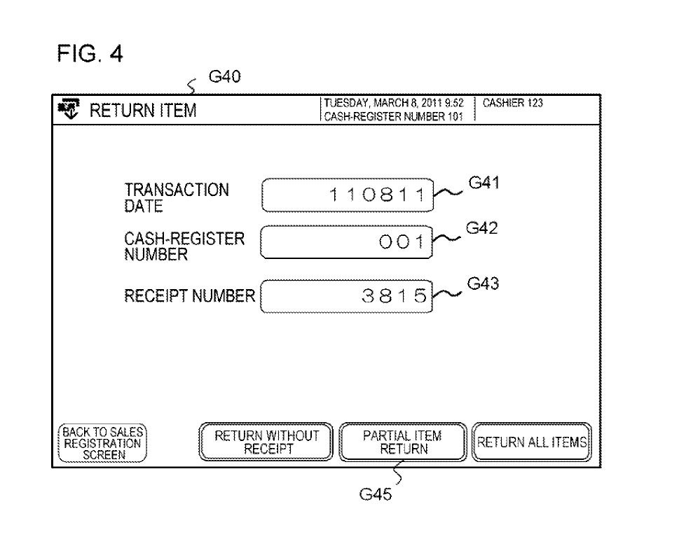

FIG. 4 is a diagram illustrating an example of a display screen for a user to identify the completed transaction including the candidate to be returned. This display screen G40 contains an input field G41 for installation date, an input field G42 for cash-register number, and an input field G43 for receipt number. The display processing unit 103 sets information acquired through the handheld scanner 23 from a receipt presented by a purchaser into each of the input fields G41, G42, and G43. Furthermore, the display processing unit 103 may set information inputted through the touch screen 22b or the keyboard 21 into each of the input fields G41, G42, and G43.

For example, the display processing unit 103 identifies the completed transaction containing the candidate to be returned on the basis of the information set through this display screen G40, extracts sales information on this completed transaction from the journal storage unit 101, and generates completed transaction data on the basis of the extracted sales information. The display processing unit 103 causes the transaction-data retaining unit 102 to retain the completed transaction data.

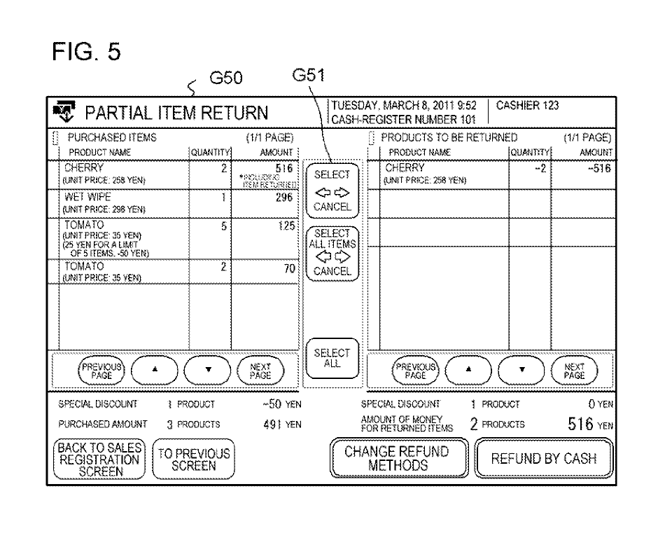

FIG. 5 is a diagram illustrating an example of an item return screen. Once detecting that a partial item return button G45 in the display screen G40 illustrated in the example in FIG. 4 is selected on the touch screen 22b or through the keyboard 21, the display processing unit 103 causes an item return screen G50 to be displayed. On the item return screen G50, the left field shows data corresponding to each statement record contained in the completed transaction data, and the right field shows data corresponding to a statement record set to be an item to be returned. The register operator uses the touch screen 22b or the keyboard 21 to select a row (data) for a candidate to be returned from a list in the left field on this item return screen G50, and presses a cancel selection button G51. The display processing unit 103 detects user operation of pressing this cancel selection button G51, and causes the judging unit 105, which will be described later, to run in response to the detection. If this user operation is judged to be valid, the display processing unit 103 sets the selected candidate to be returned to be the item to be returned, and moves this item to be returned to the right field.

The operation-information acquiring unit 104 acquires information with which it is possible to identify a statement record corresponding to the candidate to be returned selected through the user operation performed to the item return screen. More specifically, the operation-information acquiring unit 104 acquires a product code and special sales information concerning the candidate to be returned. For example, the operation-information acquiring unit 104 acquires the product code and the special sales information from the display processing unit 103 that detects the user operation performed on the item return screen. The operation-information acquiring unit 104 may further acquire information on the quantity returned concerning the candidate to be returned.

The judging unit 105 judges whether the candidate to be returned selected on the item return screen is a limited-sale-price applied product and a completed transaction associated to this candidate contains a limited-sale-price unapplied product of the same product as the candidate to be returned. More specifically, the judging unit 105 judges whether a relevant statement record is contained in the completed transaction data retained in the transaction-data retaining unit 102 and the special sales information acquired by the operation-information acquiring unit 104 indicates a limited-sales-price applied product or not, this relevant statement record being a record other than a statement record containing the product code and the special sales information acquired by the operation-information acquiring unit 104, this relevant statement record containing the product code which is the same as the acquired product code, this relevant statement record having special sales information indicating that a product thereof is not a limited sales product (limited-sales-price applied product) to which a limited sales price is applied. Here, the statement record containing the product code and the special sales information, acquired by the operation-information acquiring unit 104, corresponds to the candidate to be returned selected on the item return screen, and the relevant statement record corresponds to the limited-sale-price unapplied product of the same product as the candidate to be returned. Furthermore, a case where the special sales information indicates that the product concerning the special sales information is not a limited sales product, to which the limited sales price is applied, means a case where the limited sales price application flag is off, or a case where the discount amount is not set for this limited sales product. The judging unit 105 performs the judgment described above, for example, upon detecting that the cancel selection button G51 on the item return screen G50 illustrated in FIG. 5 is pressed by a user.

The setting processing unit 106 switches, according to judgment results obtained by the judging unit 105, processes performed in accordance with the user operations performed on the item return screen. More specifically, if the judging unit 105 judges that the special sales information acquired by the operation-information acquiring unit 104 indicates that the candidate to be returned is the limited-sales-price applied product, and the relevant statement record is contained in the completed transaction data, the setting processing unit 106 instructs the display processing unit 103 to display an alarm display for the user operation on the display unit 22a. This corresponds to a case where a limited-sales-price unapplied product is contained in the completed transaction, and the limited-sales-price applied product of the same product as this limited-sales-price unapplied product is selected as the candidate to be returned on the item return screen. With these operations, the display processing unit 103 causes the display unit 22a to display an alarm display containing particulars such as “start product returning operation from a product to which the limited sales price is not applied, from among the same products.” This alarm display may be indicated as a sign or design, or may be indicated as a text in combination thereof. This exemplary embodiment does not limit a specific mode of this alarm display.

Furthermore, in the case where the judging unit 105 judges that the special sales information acquired by the operation-information acquiring unit 104 indicates that the candidate to be returned is the limited-sale-price applied product, and the relevant statement record is contained in the completed transaction data, the setting processing unit 106 may switch the candidate to be returned selected through the user operation performed on the item return screen, to data corresponding to the relevant statement record. With this operation, if the cancel selection button G51 is pressed in a state where limited-sales-price applied products (five tomatoes) are selected on the item return screen G50 illustrated in FIG. 5, the alarm display is shown, and then, the selected portions are moved to the limited-sales-price unapplied products (two tomatoes).

Moreover, in the case where the judging unit 105 judges that the special sales information acquired by the operation-information acquiring unit 104 does not indicate that the candidate to be returned is the limited-sales-price applied product, or the relevant statement record is not contained in the completed transaction data, the setting processing unit 106 sets the candidate to be returned selected through the user operation performed on the item return screen, together with a quantity returned acquired by the operation-information acquiring unit 104, as the item to be returned. With this operation, this candidate to be returned is moved to the right field on the item return screen G50 illustrated in the drawing. This corresponds to a case where no limited sales product is selected as the candidate to be returned, or a certain limited-sales-price applied product is selected as the candidate to be returned but no limited-sales-price unapplied product of the same product as the certain limited-sales-price applied product is contained in this completed transaction.

In connection with the setting process for an item to be returned, the setting processing unit 106 deletes a statement record corresponding to the item to be returned, from the completed transaction data retained in the transaction-data retaining unit 102. Furthermore, the setting processing unit 106 instructs a settlement processing unit (not illustrated) to perform settlement processing concerning the changed completed transaction again, on the basis of the completed transaction data that has been updated, and after the settlement is completed, reflects the sales information concerning the changed completed transaction onto the journal storage unit 101. Note that, in this exemplary embodiment, other return processing is not limited, provided that user operation of selecting a candidate to be returned on an item return screen is determined, and an item to be returned is set.

### Example of Operation

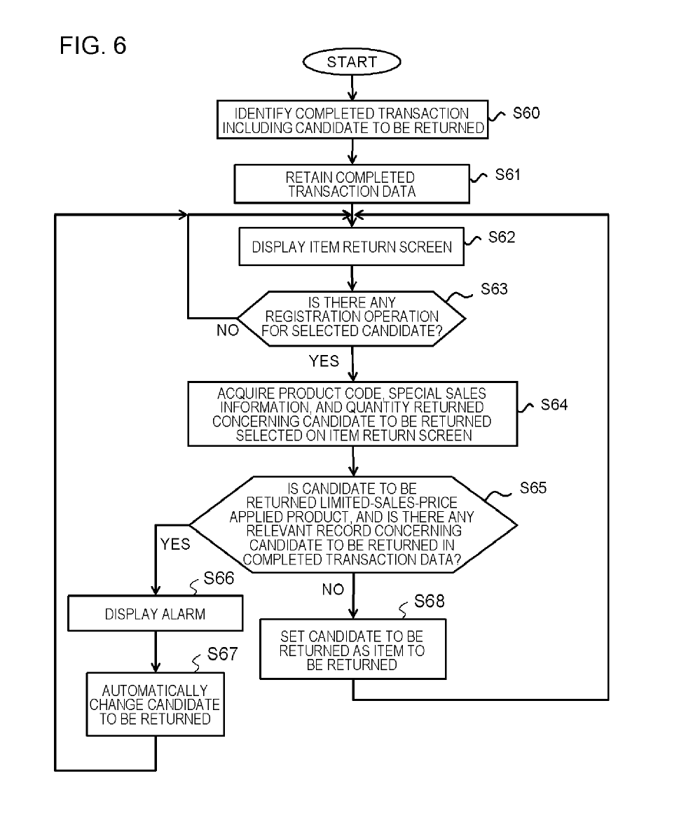

Below, a method of setting an item to be returned according to the first exemplary embodiment will be described with reference to FIG. 6. FIG. 6 is a flowchart showing an example of operations performed by the POS register device 1 according to the first exemplary embodiment at the time of setting an item to be returned. For example, each process shown in FIG. 6 is performed in the cashier device 20.

The POS register device 1 identifies a completed transaction including a candidate to be returned (S60). More specifically, the POS register device 1 causes the display unit 22a to display a screen illustrated in FIG. 4, acquires information (for example, a receipt number) with which the completed transaction including the candidate to be returned can be identified in response to input operation performed by a user on this screen, or scan operation for a receipt using the handheld scanner 23, and identifies the completed transaction on the basis of this information.

The POS register device 1 retains completed transaction data concerning this identified completed transaction in the transaction-data retaining unit 102 (S61). For example, the POS register device 1 acquires sale information concerning this completed transaction from the journal storage unit 101, and generates the completed transaction data on the basis of the acquired sales information.

The POS register device 1 causes the display unit 22a to display an item return screen as illustrated in the example in FIG. 5 using this completed transaction data (S62). A register operator operates this item return screen through the touch screen 22b or the keyboard 21 to select data corresponding to one record from among plural statement records contained in the completed transaction data as a selected candidate, thereby performing operation of registering the selected candidate. This registration operation includes, for example, pressing the cancel selection button G51 on the item return screen G50 in FIG. 5.

Upon detecting the registration operation for the selected candidate as described above (S63; YES), the POS register device 1 acquires an item return code, special sales information, and the quantity returned concerning the candidate to be returned selected on the item return screen (S64).

The POS register device 1 judges whether or not the candidate to be returned selected on the item return screen is a limited-sale-price applied product, and a limited-sale-price unapplied product of the same product as this candidate to be returned is contained in the completed transaction (S65). The specific process for the former judgment is achieved by judging whether the special sales information acquired in step S64 indicates the limited-sale-price applied product or not. The specific process for the latter judgment is achieved by judging whether the completed transaction data retained in the step (S61) contains any relevant statement record which is a record other than a statement record corresponding to the product code and the special sales information concerning the candidate to be returned acquired in step S64 and includes the product code the same as the product code concerning the candidate to be returned, and the special sales information indicating that the candidate to be returned is not a limited sales product (limited-sale-price applied product) to which a limited sales price is applied.

If the candidate to be returned is the limited-sale-price applied product and the limited-sale-price unapplied product of the same product as the candidate to be returned is contained in the completed transaction (S65; YES), the POS register device 1 causes the display unit 22a to display the alarm display (S66). This alarm display shows that the selected candidate is inappropriate and a limited-sale-price unapplied product of the same product as the candidate to be returned should be selected.

Furthermore, the POS register device 1 automatically changes this candidate to be returned to be an appropriate item (S67). With this operation, the currently selected candidate to be returned is changed from the limited-sale-price applied product to a limited-sale-price unapplied product of the same product. In such a case, the register operator checks the automatically changed candidate to be returned, and performs registration operation for a selected candidate again.

On the other hand, if the candidate to be returned is not the limited-sale-price applied product, or the candidate to be returned is the limited-sale-price applied product but no limited-sale-price unapplied product of the same product as the candidate to be returned is contained in the completed transaction (S65; NO), the POS register device 1 sets this candidate to be returned as the item to be returned because this candidate to be returned is appropriate (S68).

Furthermore, in the flowchart shown in FIG. 6, plural steps (processes) are described in a sequential order. However, the order of the steps performed is not limited to the order of the steps as described.

### Operation and Effect of First Exemplary Embodiment

As described above, in the first exemplary embodiment, an item return screen is displayed using completed transaction data formed by plural statement records each containing at least a product code that enables identification of each product included in a completed transaction, special sales information that enables determination as to whether the product is a limited-sale-price applied product, and the quantity sold, each of which concerns the completed transaction. Furthermore, user operation of selecting a candidate to be returned on this item return screen is detected, and the product code, the special sales information, and the quantity returned, each of which concerns this candidate to be returned, are acquired. On the basis of the information acquired, it is judged whether the candidate to be returned selected is a limited-sale-price applied product, and any limited-sale-price unapplied product of the same product as the candidate to be returned is contained in the completed transaction.

On the basis of the judgment results, if the candidate to be returned is the limited-sale-price applied product, and the limited-sale-price unapplied product of the same product as the candidate to be returned is contained in the completed transaction, an alarm, which indicates that this candidate to be returned is inappropriate, is displayed. Furthermore, the candidate to be returned is automatically changed from the inappropriate limited-sale-price applied product to a limited-sale-price unapplied product of the same product as the candidate to be returned.

With this operation, in the case where returning of a limited sales product is requested, it is only necessary for the register operator to perform setting operations as directed by the POS register device 1. In the case where the quantity of products contained in the completed transaction is large, there is a possibility that the item return screen does not show the limited-sale-price applied product and the limited-sale-price unapplied product, which is the same product as the limited-sale-price applied product, in a manner such that they can be viewed at a glance. In such a case, it is highly possible that a limited-sale-price applied product is wrongly selected as a candidate to be returned. In addition, in such a case, if attempts are made to appropriately select the limited-sale-price unapplied product as the candidate to be returned, there is a possibility that it would take a long time for completion.

According to the first exemplary embodiment, however, even if a limited-sale-price applied product is wrongly selected as a candidate to be returned, an alarm is displayed. Thus, it is possible to make a register operator select an appropriate candidate to be returned, eventually. Furthermore, according to the first exemplary embodiment, an error checking mechanism as described above is provided, so that it is possible to avoid expending unnecessary time for setting items to be returned. In other words, according to the first exemplary embodiment, if returning of a limited sales product is requested, it is possible to make the register operator appropriately perform setting of the item to be returned of the limited sales product.

### Modification Example

In the exemplary embodiment described above, an example is given in which the POS register device 1 has the checker device 10 and the cashier device 20. However, the POS register device 1 may be configured only with the cashier device 20. Furthermore, the item return screen described above may be displayed with the checker device 10.

In addition, the POS register device 1 according to the exemplary embodiment described above may be realized as a POS system including a server device and a mobile terminal.

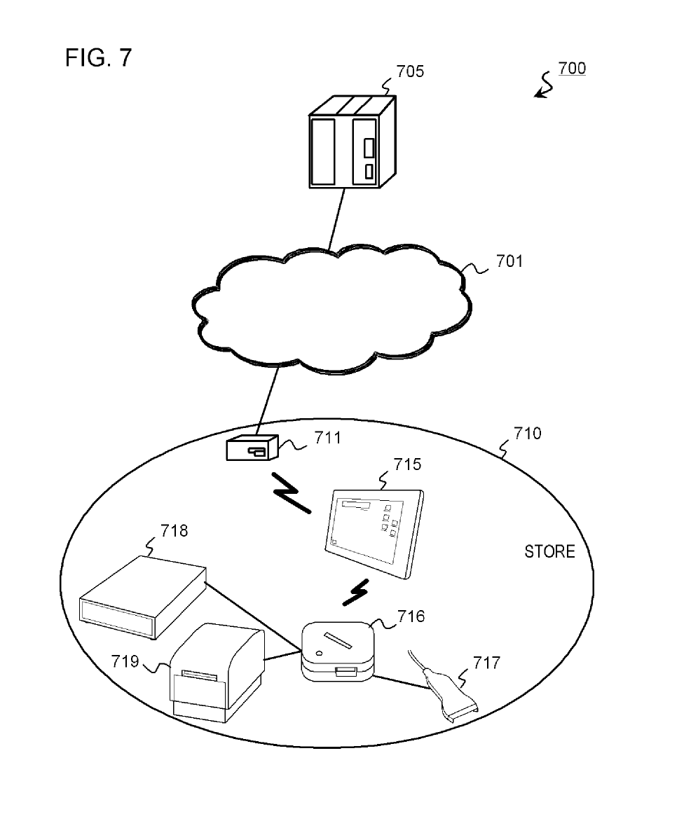

FIG. 7 is a diagram schematically illustrating an example of a configuration of a POS system 700 according to a modification example.

The POS system 700 is configured to include a server device 705 and a store-side configuration 710, and the server device 705 and the store-side configuration 710 are connected through a communication network 701 in a manner that they can communicate with each other. The communication network 701 includes, for example, a public network such as the Internet, a wide area network (WAN), a local area network (LAN), and a wireless communication network. The way in which the communication network 701 is realized is not limited.

The store-side configuration 710 includes, for example, a communication relaying device 711, a store terminal 715, a stand 716, a handheld scanner 717, a cash drawer 718, and a receipt printer 719. The stand 716 is a unit for connecting the store terminal 715 with other units (the handheld scanner 717, the cash drawer 718, and the receipt printer 719) in a manner that they can communicate with each other. The store terminal 715 and the stand 716 are connected, for example, through a short-range wireless communication such as Bluetooth (registered trademark) and an infrared communication, or a wireless LAN. The stand 716 is connected to other units through various communication lines or in a wireless manner. The communication relaying device 711 connects the store terminal 715 with the communication network 701, thereby enabling communication between the store terminal 715 and the server device 705. Note that communication modes between these nodes are not limited. It may be possible to employ a configuration in which the communication relaying device 711 is omitted, and the store terminal 715 is connected to the communication network 701, for example, using a 3G communication system, for example, through a wireless base station without passing through the communication relaying device 711.

The store terminal 715 is a general purpose computer such as a personal computer (PC), a laptop PC, a tablet-type terminal, and a smartphone, and communicates data with the server device 705, thereby achieving a user interface of the POS register device 1 described above. The server device 705 is a general server computer, and is realized, for example, as a WEB server or an application server.

In the case where the POS register device 1 according to the exemplary embodiment described above is realized as the POS system 700 as described above, each of the processing modules described above may be realized in either the server device 705 or the store terminal 715, as long as it can be realized. For example, in the case where a WEB system is used as an interface between the server device 705 and the store terminal 715, it may be possible to realize all of the processing modules described above in the server device 705, and operate the store terminal 715 as merely a display. On the contrary, it may be possible to realize all the processing modules within the store terminal 715. Furthermore, it may be possible to employ a configuration in which part of the processing modules are realized in the server device 705, and the remaining processing modules are realized in the store terminal 715. For example, it may be possible to realize the journal storage unit 101 and the transaction-data retaining unit 102 in the server device 705, and realize the other processing modules in the store terminal 715.

As described above, it is not excluded that the information processing device according to the present invention is realized with plural devices (plural computers, or a body including plural CPUs). The information processing device according to the present invention may be realized with a combination of the checker device 10 and the cashier device 20 according to the exemplary embodiment described above, or may be realized with a combination of the server device 705 and the store terminal 715 according to this modification example. Needless to say, the information processing device according to the present invention may be realized only with the cashier device 20 according to the exemplary embodiment described above, or may be realized merely with the server device 705 or the store terminal 715 according to the modification example.

The present application claims priority based on Japanese Patent Application No. 2012-173416 filed on Aug. 3, 2012, the disclosures of which are incorporated herein by reference in their entirety.

1. An information processing device, comprising:
a transaction-data retaining unit that retains completed transaction data indicating a completed transaction for which settlement processing has been already completed, the completed transaction data being formed by a plurality of statement records each including at least a product code that enables identification of each product included in the completed transaction, and special sales information that enables determination as to whether a product is a limited sales product to which a limited sales price is applied;
a display processing unit that causes a display unit to display an item return screen that enables user operation of selecting a candidate to be returned from among data corresponding to the plurality of statement records contained in the completed transaction data;
an operation-information acquiring unit that acquires the product code and the special sales information, each of which concerns the candidate to be returned selected through the user operation performed on the item return screen;
a judging unit that judges whether a relevant statement record is contained in the completed transaction data retained in the transaction-data retaining unit and the special sales information concerning the candidate to be returned indicates a limited sales product to which a limited sales price is applied or not, the relevant statement record being a record other than a statement record including the product code and the special sales information, each of which concerns the candidate to be returned, the relevant statement record including a product code the same as the product code concerning the candidate to be returned, the relevant statement record including the special sales information indicating that the product is not a limited sales product to which a limited sales price is applied; and
a setting processing unit that determines a process performed in response to the user operation, on the basis of a judgment result obtained by the judging unit.

2. The information processing device according to claim 1, wherein
if the judging unit judges that the special sales information concerning the candidate to be returned indicates that the candidate is a limited sales product to which a limited sales price is applied, and the relevant statement record is contained in the completed transaction data, the setting processing unit instructs the display processing unit to cause the display unit to display an alarm display for the user operation.

3. The information processing device according to claim 1, wherein
if the judging unit judges that the special sales information concerning the candidate to be returned indicates that the candidate is a limited sales product to which a limited sales price is applied, and the relevant statement record is contained in the completed transaction data, the setting processing unit switches the candidate to be returned selected through the user operation performed on the item return screen, to data corresponding to the relevant statement record.

4. The information processing device according to claim 1, wherein
each of the statement records of the completed transaction data further includes a quantity sold in addition to the product code and the special sales information,
the operation-information acquiring unit further acquires a quantity returned concerning the candidate to be returned in addition to the product code and the special sales information,
if the judging unit judges that the special sales information concerning the candidate to be returned indicates that the candidate is not a limited sales product to which a limited sales price is applied, or the relevant statement record is not contained in the completed transaction data, the setting processing unit sets the candidate to be returned selected through the user operation performed on the item return screen, to be an item to be returned in conjunction with the product code and the quantity returned acquired by the operation-information acquiring unit.

5. A method of setting an item to be returned, which is performed by an information processing device, the method including:
retaining, in a transaction-data retaining unit, completed transaction data indicating a completed transaction for which settlement processing has been already completed, the completed transaction data being formed by a plurality of statement records each including at least a product code that enables identification of each product included in the completed transaction, and special sales information that enables determination as to whether a product is a limited sales product to which a limited sales price is applied;
causing a display unit to display an item return screen that enables user operation of selecting a candidate to be returned from among data corresponding to the plurality of statement records contained in the completed transaction data;
acquiring the product code and the special sales information, each of which concerns the candidate to be returned selected through the user operation performed on the item return screen;
judging whether a relevant statement record is contained in the completed transaction data retained in the transaction-data retaining unit and the special sales information concerning the candidate to be returned indicates a limited sales product to which a limited sales price is applied or not, the relevant statement record being a record other than a statement record including the product code and the special sales information, each of which concerns the candidate to be returned, the relevant statement record including a product code the same as the product code concerning the candidate to be returned, the relevant statement record including the special sales information indicating that the product is not a limited sales product to which a limited sales price is applied; and
determining a process performed in response to the user operation, on the basis of a result of the judging.

6. The method of setting an item to be returned according to claim 5, further including
causing the display unit to display an alarm display for the user operation when it is judged that the special sales information concerning the candidate to be returned indicates that the candidate is a limited sales product to which a limited sales price is applied, and the relevant statement record is contained in the completed transaction data.

7. The method of setting an item to be returned according to claim 5, further including
switching the candidate to be returned selected through the user operation performed on the item return screen, to data corresponding to the relevant statement record when it is judged that the special sales information concerning the candidate to be returned indicates that the candidate is a limited sales product to which a limited sales price is applied, and the relevant statement record is contained in the completed transaction data.

8. The method of setting an item to be returned according to claim 5, wherein
each of the statement records of the completed transaction data further includes a quantity sold in addition to the product code and the special sales information,
the method further including:
acquiring a quantity returned concerning the candidate to be returned; and
setting the candidate to be returned selected through the user operation performed on the item return screen, to be an item to be returned in conjunction with the product code and the quantity returned when it is judged that the special sales information concerning the candidate to be returned indicates that the candidate is not a limited sales product to which a limited sales price is applied, or the relevant statement record is not contained in the completed transaction data.

9. A non-transitory computer-readable storage medium storing a program for causing an information processing device to perform a method of setting an item to be returned, the method including:
retaining, in a transaction-data retaining unit, completed transaction data indicating a completed transaction for which settlement processing has been already completed, the completed transaction data being formed by a plurality of statement records each including at least a product code that enables identification of each product included in the completed transaction, and special sales information that enables determination as to whether a product is a limited sales product to which a limited sales price is applied;
causing a display unit to display an item return screen that enables user operation of selecting a candidate to be returned from among data corresponding to the plurality of statement records contained in the completed transaction data;
acquiring the product code and the special sales information, each of which concerns the candidate to be returned selected through the user operation performed on the item return screen;
judging whether a relevant statement record is contained in the completed transaction data retained in the transaction-data retaining unit and the special sales information concerning the candidate to be returned indicates a limited sales product to which a limited sales price is applied or not, the relevant statement record being a record other than a statement record including the product code and the special sales information, each of which concerns the candidate to be returned, the relevant statement record including a product code the same as the product code concerning the candidate to be returned, the relevant statement record including the special sales information indicating that the product is not a limited sales product to which a limited sales price is applied; and
determining a process performed in response to the user operation, on the basis of a result of the judging.

10. A non-transitory computer-readable storage medium according to claim 9, the method further including
causing the display unit to display an alarm display for the user operation when it is judged that the special sales information concerning the candidate to be returned indicates that the candidate is a limited sales product to which a limited sales price is applied, and the relevant statement record is contained in the completed transaction data.

11. A non-transitory computer-readable storage medium according to claim 9, the method further including
switching the candidate to be returned selected through the user operation performed on the item return screen, to data corresponding to the relevant statement record when it is judged that the special sales information concerning the candidate to be returned indicates that the candidate is a limited sales product to which a limited sales price is applied, and the relevant statement record is contained in the completed transaction data.

12. A non-transitory computer-readable storage medium according to claim 9, wherein
each of the statement records of the completed transaction data further includes a quantity sold in addition to the product code and the special sales information,
the method further including:
acquiring a quantity returned concerning the candidate to be returned; and
setting the candidate to be returned selected through the user operation performed on the item return screen, to be an item to be returned in conjunction with the product code and the quantity returned when it is judged that the special sales information concerning the candidate to be returned indicates that the candidate is not a limited sales product to which a limited sales price is applied, or the relevant statement record is not contained in the completed transaction data.
